(19) United States
(12) Patent Application Publication
(10) Pub. No.: US 2006/0230760 A1
(43) Pub. Date: Oct. 19, 2006

(54) Self-sustaining on-site production of electricity utilizing oil shale and/or oil sands deposits

(76) Inventor: William B. Hendershot, Delaware, OH (US)

Correspondence Address: STALLMAN & POLLOCK LLP, 353 SACRAMENTO STREET, SUITE 2200, SAN FRANCISCO, CA, 94111, US

(21) Appl. No.: 11/429,907

(22) Filed: May 8, 2006

Related U.S. Application Data
(63) Continuation-in-part of application No. 11/093,690, filed on Mar. 30, 2005.
Application No. 11/093,690 is a continuation-in-part of application No. 10/618,948, filed on Jul. 14, 2003, now abandoned.
(60) Provisional application No. 60/560,498, filed on Apr. 7, 2004.

(51) Int. Cl. B60K 16/00; F01K 13/00; B60L 8/00; F03G 6/00

(52) U.S. Cl. 60/641.8; 60/645

(57) ABSTRACT

Oil shale and/or oil sands are utilized to generate electricity at the site of the oil shale/sands deposit. Bulk shale/sands material is removed from the deposit and provided to a burn container. Hydrocarbons contained in the bulk material are combusted in the burn container to generate thermal energy. The thermal energy is utilized to heat water to generate steam. The steam is utilized to drive a steam turbine power generator located in close proximity to the deposit to generate electricity. The electricity is distributed off-site using a conventional distribution system or, alternately, a portion of the electricity generated on-site may be utilized in various aspects of the energy recovery process to make it self-sustaining. The use and recycling of resources and energy developed at the site of the deposit can further contribute to the self-sustaining nature of the recovery process.

### RELATED APPLICATIONS

This patent application is a Continuation-In-Part of co-pending application Ser. No. 11/093,690, filed on Mar. 30, 2005, by William B. Hendershot, titled “Self-Sustaining On-Site Production of Electricity Utilizing Oil Shale”, which (1) is a Continuation-In-Part of application Ser. No. 10/618,948, filed on Jul. 14, 2003, by William B. Hendershot, titled “On-site Production of Electricity Utilizing Oil Shale”, now abandoned, and (2) claims the benefit of Provisional Patent Application No. 60/560,498, filed on Apr. 7, 2004, by William B. Hendershot, titled “On-site Production of Electricity Utilizing Oil Shale.” application Ser. No. 11/093,690, application Ser. No. 10/618,948, and Provisional Patent Application No. 60/560,498 are each hereby incorporated by reference in their entirety.

### BACKGROUND OF THE INVENTION

1. Field of the Invention

The present invention relates to energy production from oil shale and/or oil sands deposits and, in particular, to an efficient technique for producing electricity and/or hydrocarbon products in close proximity to the site of an oil shale/sands deposit and utilizing a portion of the on-site-generated electricity and/or the on-site produced hydrocarbon products in the energy recovery process to maximize the self-sustaining nature of the process. The use and recycling of resources and heat energy developed at the site of the oil shale/sands deposit further contributes to the self-sustaining aspect of the invention.

2. Discussion of the Related Art

As discussed in a 2005 report authored by Bartis et al. for the RAND Corporation and titled “Oil Shale Development in the United States”, it is well known that there are very large oil shale deposits in a number of locations throughout the world. These oil shale deposits hold some of the largest oil reserves in the world. The reason that only a very small amount of this oil is currently extracted from these deposits for use in producing energy is the prohibitively high cost, in terms of both economics and environmental impact, associated with extracting the oil from the oil shale. The RAND Corporation report provides a detailed discussion of the prospects and policy issues related to oil shale development in the United States. Similar issues apply to the vast oil sands deposits that exist in North America, primarily in Canada.

A number of methods for recovering oil from oil shale have been proposed. The technology disclosed in U.S. Pat. No. 4,265,307, issued on May 5, 1981 and titled “Shale Oil Recovery”, is an example.

As discussed in '307 patent, oil shale is composed of inorganic matter (rock) and organic matter called “kerogen.” When oil shale is heated at elevated temperatures on the order of 600° F. to 900° F. in the absence of significant oxygen, kerogen is destructively distilled to form a hydrocarbon gas, shale oil and carbon. Shale oil at elevated temperature is in the vapor phase, while the carbon is in the form of coke. Continued heating of shale oil causes decomposition to form more gas and more coke.

As further discussed in the '307 patent, beginning in the 1920's, the first proposals for recovering oil from shale were referred to as “true in situ combustion.” As the name suggests, these methods involved the in situ, or in the ground, combustion of the oil shale. Heat necessary for recovering the hydrocarbons was to be supplied by in situ combustion, combustion being accomplished along a combustion front that moved from one end of the oil shale deposit to the other end of the deposit during the recovery operation.

The true in situ combustion technique was first tried in the 1950's and was attempted a number of times in the 1950's and the 1960's. In carrying out this process, small fissures were introduced into the oil shale deposit by hydrofrac techniques prior to combustion in order to expedite the passage of vaporous shale oil out of the bed. Unfortunately, the true in situ combustion technique was not successful.

In the early 1970's, a modification of the true in situ combustion technique was first tried. This technique, referred to as the “modified in situ combustion technique”, differs from the true in situ combustion technique in that, prior to in situ combustion, partial mining around the oil shale deposit is accomplished to provide a greater flow path for the escape of the shale oil. Also prior to combustion, the shale oil deposit is broken up or fragmentized (referred as “rubblized”) into chunks or pieces. This is usually accomplished by means of explosives. However, the modified in situ combustion technique also proved to be ineffective in larger shale oil deposits, where yields were only around 30% of theoretical.

U.S. Pat. No. 4,472,935, issued to Acheson et al. on Sep. 25, 1984, discloses an example of a modified in situ oil shale combustion technique. In accordance with the method disclosed in the '935 patent, a subsurface oil shale formation is penetrated by both a production well and an injection well. While the shale itself remains in the ground, the fluids produced by the production well are delivered through a line into an above ground separator in which low heating value (LHV) gases in the produced fluids are separated from the liquids in the produced fluids. The liquids are discharged from the bottom of the separator into a line for off-site delivery and the LHV gases are discharged from the top of the separator into a feed line. The LHV gases are preheated, mixed with air and then burned in a catalytic combustion chamber. The combustion products discharged from the combustion chamber are then expanded in a turbine to generate electricity.

In addition to in situ combustion, other techniques have been proposed for the recovery of shale oil from oil shale by the in situ heating of the oil shale. These techniques include the utilization of electrical energy for heating the oil shale and the utilization of radio frequency energy rather than combustion to furnish the necessary heat.

Oil sands deposits are typically exploited using either the modified in situ combustion technique described above or an open pit mining process.

The modified in situ combustion technique involves the process described in the above-cited Acheson et al. '935 patent, wherein both a production well and an injection well are formed in the oil sands deposit. The injection well is used to drive heat into the deposit, forcing the “bitumen” hydrocarbons in the deposit into the production well for extraction.

In the more commonly used open pit mining technique, the bitumen-containing oil sands are removed from the deposit using scooping and conveyor systems. The extracted bulk oil sands are then transported to a processing facility using either huge dump trucks or a water-slurry transport system. The processing plant uses water to separate the bitumen form the sand. The bitumen is then processed to remove impurities and then further processed in a coking tower system that ultimately provides a “sweet crude” hydrocarbon product. The open pit mining technique is clearly environmentally insensitive and energy inefficient.

While, as indicated above, numerous attempts have been made to effectively capture oil from oil shale and/or oil sands deposits over the years, no technique has yet been developed that provides a commercially-viable and environmentally-sensitive production level technique for recovering energy from these huge deposits.

### SUMMARY OF THE INVENTION

The present invention provides systems and methods for generating electricity and/or hydrocarbon products in close proximity to oil shale and/or oil sands deposits and, preferably, with optimum utilization of local supplemental energy resources and recycled energy and materials.

In accordance with the general concepts of the invention, an electrical power generating facility is located in close proximity to an oil shale deposit or an oil sands deposit (hereinafter referred to inclusively as an “oil shale/sands deposit”). Oil shale/sands removed from the deposit is provided to an on-site, above ground burn container in bulk form. Supplemental heat energy, preferably obtained from on-site fuel resources and/or recycled materials, may be provided to supplement the combustion process in the on-site burn container. The heat energy generated by the combustion process in the burn container is utilized to heat water to generate steam. The steam drives a steam turbine power generator that is part of the on-site power generating facility. The steam turbine generates electricity that can be distributed off-site as desired. A portion of the on-site generated electricity can also be utilized at the site in the energy recovery process, thereby contributing to the self-sustaining nature of the on-site power generation process.

These and additional features and advantages of the present invention will be more fully appreciated upon consideration of the following detailed description of the invention and the accompanying drawings that set forth a number of illustrative embodiments in which the concepts of the invention are utilized.

### BRIEF DESCRIPTION OF THE DRAWINGS

FIG. 1 is a block diagram illustrating an embodiment of a system and method for generating electricity from oil shale/sands deposits in accordance with the concepts of the present invention.

FIG. 2 is a block diagram illustrating a more detailed embodiment of a system and method for generating electricity from oil shale/sands deposits in accordance with the concepts of the present invention.

FIG. 3 is a schematic drawing illustrating a dual parabolic solar reflector utilizable in generating electricity from oil shale/sands deposits in accordance with the concepts of the present invention.

FIG. 4 is a schematic drawing illustrating an alternate embodiment of a dual parabolic solar reflector utilizable in generating electricity from oil shale/sands deposits in accordance with the concepts of the present invention.

FIG. 5 is a block diagram illustrating an alternate embodiment of a system and method for generating electricity and/or hydrocarbon products from oil shale/sands deposits in accordance with the concepts of the present invention.

FIGS. 6A-6D illustrate utilization of spent hot oil shale/oil sands to preheat bulk oil shale/oil sands input to a recovery vessel in accordance with the concepts of the present invention.

### DETAILED DESCRIPTION OF THE INVENTION

The present invention provides a technique that utilizes oil shale and/or oil sands to generate electricity in close proximity to the site of the oil shale/sands deposit. Electricity generated at the site of the deposit can be utilized in the energy recovery process to contribute to the self-sustaining nature of the process.

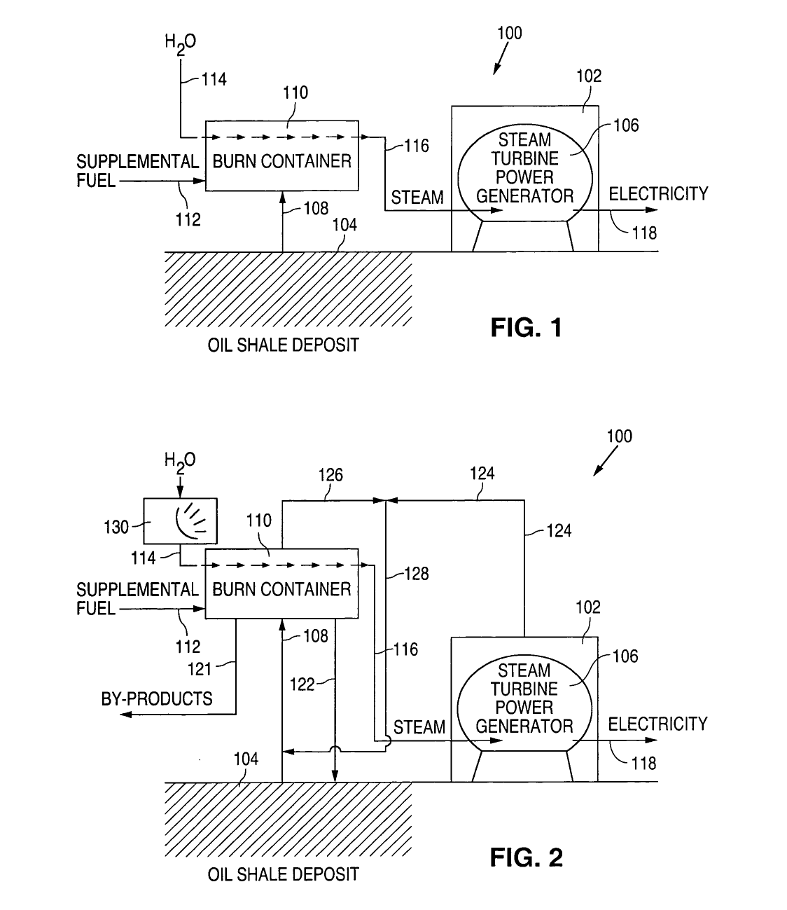

FIG. 1 shows one embodiment of a system 100 for generating electricity utilizing oil shale and/or oil sands in accordance with the present invention.

The system 100 includes an electrical power generating facility 102 that is located in close proximity to an oil shale/sands deposit 104. It is desirable to locate the electrical generating facility 102 as close to the deposit 104 as possible, the location of the facility 102 being dependant upon local conditions, including the size of the deposit 104 itself. The distance from the deposit 104 to the generating facility should, preferably, be less than 20 miles.

The power generating facility 102 includes a steam turbine power generator 106 of the conventional type utilizable for generating electricity. As indicated in FIG. 1, in accordance with this embodiment of the invention, oil shale and/or oil sands 108 in bulk form (i.e., greater than about 1.5 in. diameter in the case of oil shale) is removed from the deposit 104 and provided to an on-site, above ground conventional burn container 110, such as, for example, a fluidized bed reactor. Those skilled in the art will appreciate that, in the case of oil shale, the bulk oil shale 108 can be “rubblized” or “pulverized” (i.e., crushed to pieces less than about 1.5 in. diameter) prior to its introduction into the above ground burn container 110. Supplemental fuel 112, which can be, for example, propane, but which preferably is fuel obtained from a renewable source local to the deposit 104 (e.g., ethanol obtained from corn grown in proximity to the deposit 104) may be provided to the burn container 110 such that hydrocarbons contained in the bulk oil shale/sands 108 are combusted in the burn container 110 to generate thermal energy. The thermal energy generated by the burn container 110 is utilized to heat water 114, preferably provided by a local source, to generate steam 116. The steam 116 drives the steam turbine power generator 106 to generate electricity 118 that can be distributed as desired utilizing a conventional electricity distribution system or grid. (As discussed in greater detail below, a portion of the on-site generated electricity 118 can be used on-site to make the power generation process more self-sustaining.)

FIG. 2 shows a more detailed embodiment of the FIG. 1 system 100. As shown in FIG. 2, recoverable by-products 121 resulting from the combustion of bulk oil shale/sands 108 in the above ground burn container 110 include fine potash, including potassium carbonate and potassium hydroxide. It is well known that potassium carbonate is used as a granular powder in making glass, enamel and soaps; potassium hydroxide is a caustic white solid used as bleach and in making soap, common dyes and alkaline batteries (lye). Thus, the commercial need for potassium carbonate and potassium hydroxide could justify the cost of disposing of this by-product of the burn container 110. Furthermore, the spent rock and/or sands 122 resulting from the combustion of the oil shale/sands 108 in the burn container 110 can be returned to the original deposit 104 to minimize the environmental impact of “mining” the bulk oil shale/sands 108.

As in the FIG. 1 system, thermal energy generated in the burn container 110 heats water 114, preferably from a local source, to produce steam 116 that drives a steam turbine generator 106. Steam turbine generator 106 generates electricity 118 that is exported for off-site use. (As stated above and discussed in greater detail below, a portion of the on-site generated electricity 118 can be used in the generation process.)

As further shown in FIG. 2, exhaust steam heat 124 from the steam turbine power generator 106 and/or exhaust heat 126 from the burn container 110 can be recycled and used to provide preheat energy 128 to the bulk oil shale/sands 108 as it comes from the deposit 104 to the burn container 110. The combination of the recycled preheat energy 128 and the supplemental fuel 112 can result in a temperature that will cause the bulk oil shale/sands 108 entering the burn container 110 to be easily crumpled to a fine powder, thereby facilitating removal of the shale oil and other hydrocarbons contained in the bulk material 108 as it is heated in the burn container 110. As mentioned above, if the heat provided from these supplemental and/or recycled sources is insufficient, some amount of refining, e.g., rubblizing/pulverizing of bulk oil shale, may be required prior to introduction of the bulk material 108 into the burn container 110 to facilitate more efficient recovery of thermal energy from the shale oil hydrocarbons contained in the bulk material 108. Crushing can be powered utilizing the excess steam 124 and/or the electricity 118 generated on-site.

Alternatively, some form of radiant energy, e.g. microwaves, could be used to preheat the bulk material 108, thereby dissolving the kerogen contained therein. As in the FIG. 1 embodiment, the supplemental fuel 112 provided to the burn container 110 can be propane or other locally obtained waste material such as for example, wood, sawdust, trash or manure that can be utilized to generate heat in the burn container 110 or to preheat the bulk material 108.

As further shown in FIG. 2, the water 114 utilized to generate steam 116 for driving the steam turbine power generator 106 can be preheated utilizing a parabolic solar reflector system 130 (described in greater detail below).

The steam exhaust heat 124 from the steam turbine power generator 106, which typically will be around 350 degrees F., can also be utilized to assist in the fermentation of locally grown corn to produce ethanol as a supplemental fuel 112 for the burn container 110. Alternatively, the ethanol could be used in dissolving kerogen contained in the bulk material 108, thereby improving the efficiency of the combustion process in the burn container 110.

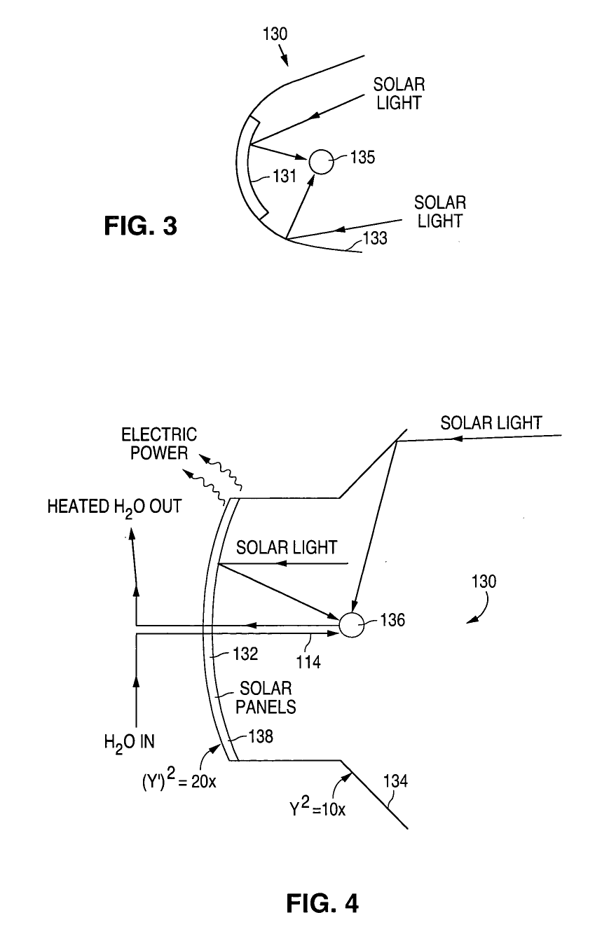

FIG. 3 shows an embodiment of a parabolic solar reflector system 130 that can be used in the FIG. 2 system. The center of the parabolic reflector system 130 near the axis, which is flatter and more perpendicular to the sun's rays, is used to generate electrical energy utilizing solar panels 131 mounted on the parabolic reflector surface 133. The outer edge reflects solar rays to a black sphere 135 located at a focal point to heat the water ultimately provided as the steam source to the turbine generator 106.

As stated above, exhaust steam 124 from the steam turbine power generator 106 can be used to preheat the bulk material 108 or can be reused as input to the steam tank.

FIG. 4 provides a more detailed illustration of a preferred embodiment of a parabolic solar reflector system 130. In the FIG. 4 embodiment, the parabolic reflector 130 includes a first parabolic reflecting surface 132 having a first curvature that conforms, as illustrated, to the equation Y²=20×. The parabolic reflector 130 also includes a second parabolic reflecting surface 134 that conforms to a second equation, shown in FIG. 3 as Y²=10×. Both the first parabolic reflecting surface 132 and the second parabolic reflecting surface 134 have the same focal point. A black sphere 136 located at the common focal point of the first parabolic reflecting surface 132 and the second parabolic reflecting surface 134 receives water 114 from the input source and provides preheated water to the burn container 110 for generation of steam 116. As further shown in FIG. 4, the first parabolic reflecting surface 132 of the parabolic reflector 130 has solar collectors 138 mounted thereon for generating electricity from the solar energy captured by the solar collectors. The system 130 can include solar tracking equipment that continuously adjusts the position of the reflecting surfaces 132, 134 in response to changes in the position of the sun to obtain maximum capture of solar energy.

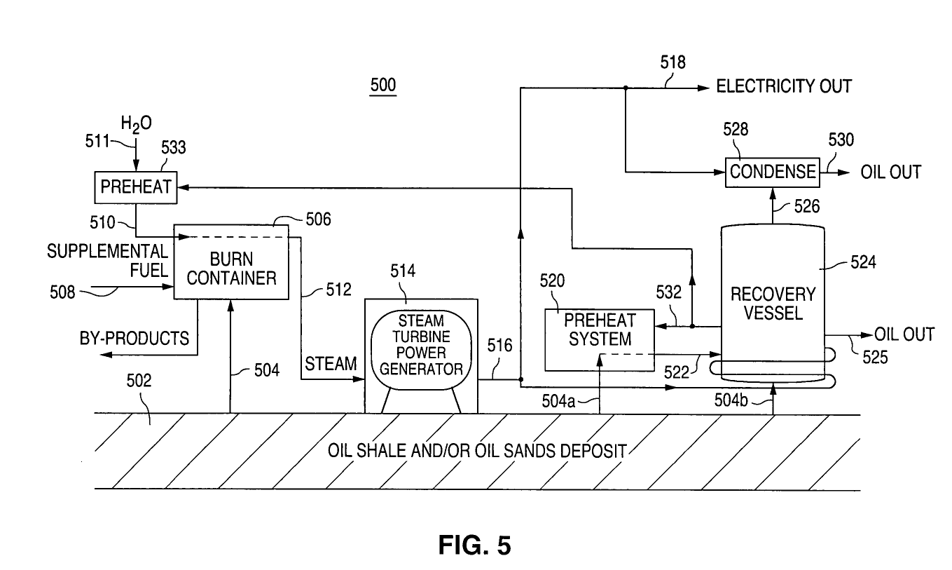

FIG. 5 illustrates an alternate embodiment of a system 500 for the self-sustaining generation of electricity using oil shale and/or oil sands removed from an oil shale/sands deposit 502. As in the above-described embodiments of the invention, oil shale and/or oil sands in bulk form 504 are removed from the deposit 502 and provided to an on-site, above ground burn container 506, such as, for example, a fluidized bed reactor. As discussed above, supplemental fuel 508 may be provided to the burn container 506 such that hydrocarbons contained in the bulk material 504 are combusted to generate thermal energy within the burn container 506. Thermal energy generated in the burn container 506 is utilized to heat water 510, preferably from a local source 511, to generate steam 512. The steam 512 drives a steam turbine power generator 514 that generates electricity 516 for off-site distribution 518; as discussed below, a portion of the electricity generated on-site can be used in the energy recovery process.

As further shown in FIG. 5, bulk material 504a may also be removed from the deposit 502 and provided to a preheat system 520. Preheated bulk material 522 from the preheat system 520 is provided to a surface recovery vessel 524 in which heat is used to drive hydrocarbons from the preheated bulk oil shale/sands material 522 in liquid form 525 and/or in vapor form 526, as is done in conventional surface oil shale retorting processes; in contrast to the conventional surface retorting technique, the heat required for the surface recovery vessel 524, preferably, all derives from the deposit 502. The hydrocarbon vapors 524 driven from the bulk material 522 are cooled in a condenser 528 to provide liquid oil and/or hydrocarbon product 530 that can be distributed off-site together with the liquid product 525; a portion of the product 525, 530 can used as supplemental fuel in various other stages of the recovery process. Condenser 528 may be cooled using water, which, in this case, would require additional use of water from the local source 511. However, as shown on FIG. 5, preferably, the condenser 528 is electrically driven by power 518 generated by the on-site generator 514, thereby reducing the burden on the local water resource 511.

Also, although not shown in the FIG. 5 block diagram, a portion (preferably less than 20%) of the oil/hydrocarbon output 525, 530 of the surface recovery vessel 524 can be recycled to assist combustion in any or all of the burn container 506, the preheat system 534 and the surface recovery vessel 524 itself. The combustion efficiency in each of these systems can be optimized by varying the percentage of the various fuels used in the system. Also, if one or more of these systems is not functioning properly at any given time, the generation of electricity and oil/hydrocarbon product can continue by simply increasing the utilization of the other systems. For example, the burn container 506 can act as a buffer to supply larger amount of electricity while the surface recovery vessel 524 is being loaded/unloaded between cycles.

As further shown in FIG. 5, a portion of the electrical 516 energy generated by the steam turbine power generator 514 can be utilized to heat the surface recovery vessel 524. Furthermore, supplemental heat for the recovery vessel 524 can be obtained by the combustion of bulk oil shale/sands material 504b taken from the deposit 502.

As additionally shown in FIG. 5, spent bulk material 532 that results from the heating process in the surface recovery vessel 524, and that can have a temperature in the range of 450° C., can be provided to a preheat system 533 in which the water 510 is preheated prior to introduction to the burn container 506, thereby reducing the fuel burden on the burn container 506 and increasing the overall efficiency of the system 500.

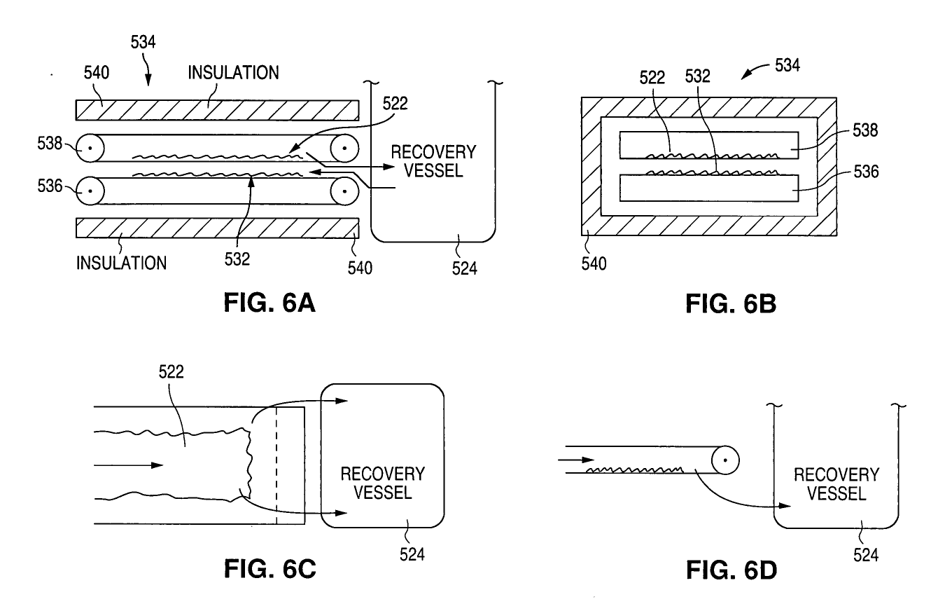

FIGS. 6a-6d combine to show an embodiment of a preheating system 520 (FIG. 5) that can be utilized to preheat the bulk material 504a that is provided to the surface recovery vessel 524. As shown in the side view of FIG. 6a and its corresponding cross section in FIG. 6b, the preheat system 520 includes a lower conveyer belt 536 that runs in a direction (shown by the lower arrow) that carries spent material from the recovery vessel 524 and a second, upper conveyer belt 538 that runs in an opposite direction to deliver bulk material 504a from the deposit 502 to the recovery vessel 524. The dual-conveyer belt system 536, 538 is surrounded by insulation 540 on all four sides, as illustrated in FIGS. 6a and 6b, in order to minimize heat loss and, thus, obtain maximum benefit of the recycled heat provided by the spent material 532 from the recovery vessel 524. Thus, oil sand/shale material 502a to be input to the recovery vessel 524 can be preheated by spent hot shale/sand material 532 that is removed from the recovery vessel 524 and passes on the lower conveyer 536 in an opposite direction. The volume of the spent shale/sands material 532 and preheated oil shale/sands 522 on the conveyor belts can equal a full load in the recovery vessel 524; however, up to 25% of the spent shale/sands 532 at 450° C. could remain in the recovery vessel 524 for use in preheating the next cycle of bulk material introduced to the vessel 524. FIGS. 6c and 6d provide details of the transfer of spent shale/sand 532 and pre-heated oil shale/sand 522 to and from the recovery vessel 524, respectively.

It should be understood that, although FIG. 5 shows the utilization of only one steam turbine generator 514 in the system 500 that provides power directly to a power grid, multiple steam generators could be utilized with some of the generators providing power to the grid and others providing power for use in the energy recovery process. Using a number of smaller generators (e.g., one steam generator per four square miles of the overall oil shale/sands deposit 502) would, thus, provide greater flexibility to the system 500. The use of small portable steam generators would enable these generators to be moved from site to site on the deposit 502 as the different areas of the deposit 502 are developed, thereby reducing the overall cost of energy production.

It should also be understood that systems of the type described above could include the latest available pollution control technology. For example, all of the hydrocarbon combustion systems could be fitted with scrubbers to minimize air pollution.

The techniques defined and described above for converting oil shale and/or oil sands to electrical energy require the building of a large electric power trunk from the on-site oil shale fields or transportation of the mined oil shale to conversion plants located nearer to the power trunks. However, if the electric power generated on site is used to power the harvesting of oil from the oil shale/sands, then the efficiency of the process can be greatly improved, ultimately to the point of making the process self-sustaining.

All steps of the processes needed for the on-site generation of electricity from oil shale can be facilitated by the electric power generated from on-site. For example, the following can be achieved by using this electricity:
raw mining of oil shale and/or oil ands
removal of raw oil shale/oil sands from the mine
crushing oil shale
heating crushed oil shale and/or oil sands to the point of evaporation
condensing oil vapor to reclaim the liquid oil
pumping the liquid oil to a desired location for cracking

Other on-site functions can also utilize this electricity. Thus, the self-sustained on-site conversion of oil shale and/or oil sands to electrical energy and/or oil can be facilitated by the techniques described above.

It should be understood that various alternatives to the embodiments of the invention described herein might be employed in practicing the invention. It is intended that the following claims define the scope of the invention and that methods and systems within the scope of these claims and their equivalents be covered thereby.

What is claimed is:

1. A method of generating electricity utilizing an oil shale/sands deposit, the method comprising:
locating an electrical power generating facility that includes a steam turbine power generator in close proximity to the oil shale/sands deposit;
removing oil shale/sands from the oil shale/sands deposit in bulk form;
providing the removed oil shale/sands to an above ground burn container;
providing supplemental fuel to the burn container such that hydrocarbons contained in the oil shale/sands provided to the burn container are combusted to generate thermal energy;
using the thermal energy generated by the burn container to heat water to generate steam;
providing the steam to the steam turbine power generator such that the steam turbine power generator generates electricity on the site of the oil shale/sands deposit.

2. A method as in claim 1, and wherein the oil shale/sands deposit comprises oil shale.

3. A method as in claim 1, and wherein the oil shale/sands provided to the above ground burn container comprises rubblized oil shale.

4. A method as in claim 1, and wherein the oil shale/sands provided to the above ground burn container comprises pulverized oil shale.

5. A method as in claim 1, and further comprising:
recovering potash generated by combustion of the oil shale/sands hydrocarbons.

6. A method as in claim 1, and further comprising:
returning spent oil shale/sands resulting from combustion of the oil shale/sands hydrocarbons to the oil shale/sands deposit.

7. A method as in claim 1, and further comprising:
preheating the water prior to utilizing the thermal energy generated by the burn container to heat the water to generate steam.

8. A method as in claim 7, and further comprising:
preheating the water utilizing a parabolic solar reflector.

9. A method as in claim 8, and further comprising:
adjusting the position of the parabolic reflector to track the position of the sun.

10. A method as in claim 7, and further comprising:
preheating the water utilizing a dual parabolic reflector that includes a first parabolic surface having a focal point and a second parabolic reflecting surface having the same focal point as the first parabolic reflecting surface, the water being passed through the common focal point of the first and second parabolic reflecting surfaces.

11. A method as in claim 10, and wherein the first parabolic reflecting surface has solar collectors mounted thereon for generating electricity from solar energy captured by the solar collectors.

12. A method as in claim 1, and wherein the supplemental fuel includes propane.

13. A method as in claim 1, and wherein the supplemental fuel is obtained from a source located in close proximity to the oil shale/sands deposit.

14. A method as in claim 13, and wherein the supplemental fuel comprises ethanol derived from a crop grown in close proximity to the oil shale/sands deposit.

15. A method as in claim 1, and further comprising:
utilizing exhaust heat from the electrical power generating facility to heat the oil shale/sands provided to the burn container.

16. A method as in claim 1, and further comprising:
utilizing exhaust heat from the electrical power generating facility to pre-heat the oil shale/sands prior to its introduction to the burn container.

17. A method as in claim 1, and further comprising:
providing supplemental fuel to the pre-heat the oil shale/sands prior to its introduction to the burn container.

18. A method of generating electricity utilizing an oil shale/sands deposit, the method comprising:
removing oil shale/sands from the oil shale/sands deposit in bulk form;
combusting the removed bulk oil shale/sands above ground to generate heat energy;
utilizing the heat energy at the site of the oil shale/sands deposit to generate electricity;
utilizing at least some of the generated electricity in the removing and/or combusting steps.

19. A system that generates electricity utilizing an oil shale/sands deposit, the system comprising:
an above ground burn container that utilizes oil shale/sands from the oil shale/sands deposit to generate thermal energy; and
a power generator that generates electricity using the thermal energy generated by the burn container.

20. A system as in claim 19, and wherein the oil shale/sands utilized by the above ground burn container comprises bulk oil shale.

21. A system as in claim 19, and wherein the oil shale/sands comprises pulverized oil shale.

22. A system as in claim 19, and wherein the oil/shale sands comprises oil sands.

23. A method of generating electricity and hydrocarbon products utilizing an oil shale/sands deposit, the method comprising:
locating an electrical power generating facility that includes an on-site steam turbine power generator in close proximity to the oil shale/sands deposit;
removing oil shale/sands from the oil shale/sands deposit in bulk form;
providing a first portion of the removed oil shale/sands to an above ground burn container;
combusting the first portion of the removed oil shale/sands in the above ground burn container to generate thermal energy;
utilizing the thermal energy generated by the above ground burn container to heat water to generate steam;
utilizing the steam to drive the steam turbine power generator to generate electricity;
providing a second portion of the removed oil shale/sands to a surface recovery vessel for the recovery of hydrocarbon products contained in the second portion of the removed oil shale/sands.

24. A method as in claim 23, and further comprising:
providing the electricity generated by the steam turbine power generator to a power grid that is off-site from the oil shale/sands deposit.

25. A method as in claim 23, and further comprising:
providing a first portion of the electricity generated by the steam turbine power generator to a power grid that is off-site from the oil shale/sands deposit; and
utilizing a second portion of the electricity generated by the steam turbine power generator in the method of generating electricity and hydrocarbon products.

26. A method as in claim 25, and further comprising:
utilizing the second portion of the electricity generated by the steam turbine power generator in the recovery of hydrocarbon products by the surface recovery vessel.

27. A method as in claim 23, and further comprising:
providing the hydrocarbon products recovered by the surface recovery vessel to a hydrocarbon distribution system that is off-site from the oil shale/sands deposit.

28. A method as in claim 23, and further comprising:
providing a first portion of the hydrocarbon products recovered by the surface recovery vessel to a hydrocarbon distribution system that is off-site from the oil shale/sands deposit; and
utilizing as second portion of the hydrocarbon products recovered by the surface recovery vessel in the method of generating electricity and hydrocarbon products.

29. A method as in claim 28, and further comprising:
pre-heating the second portion of removed oil shale/sands prior to providing the second portion of removed oil shale/sands to the surface recovery vessel.

30. A method as in claim 29, and further comprising:
pre-heating the second portion of removed oil/shale sands utilizing spent oil shale/sands removed from the surface recovery vessel.

31. A method as in 23, and further comprising:
utilizing spent oil shale/sands removed from the surface recovery vessel to preheat the water utilized to make steam to drive the steam turbine power generator.

32. A method as in claim 25, and further comprising:
utilizing the second portion of the electricity generated by the steam turbine power generator to condense hydrocarbon vapors generated by the surface recovery vessel.

33. A system that generates electricity and hydrocarbon products utilizing an oil shale/sands deposit, the system comprising:
an electrical power generating system that includes an on-site steam turbine power generator located in close proximity to the oil shale/sands deposit:
an above ground burn container that combusts oil shale/sands material removed from the oil shale/sands deposit to produce thermal energy utilized to produce steam that drives the steam turbine power generator to generate electricity; and
an on-site surface recovery vessel that recovers hydrocarbon products from oil shale/sands material removed from the oil shale/sands deposit.

34. A system as in claim 33, and wherein the electrical power generating system comprises a plurality of steam turbine power generators each installed at a different location in close proximity to the oil shale/sands deposit, each of the plurality of steam turbine power generators generating electricity by being driven by steam generated at the site of the oil shale/sands deposit.

35. A system as in claim 34, and wherein the electricity generated by a first number of the plurality of steam turbine power generators is provided to an off-site power grid and the electricity generated by a second number of the plurality of steam turbine power generators is used on-site to generate electricity and/or hydrocarbon products.

36. A system as in claim 33, and wherein the hydrocarbon products recovered by the surface recovery vessel are provided to an off-site hydrocarbon product distribution system.

37. A system as in claim 33, and wherein a first portion of the hydrocarbon products recovered by the surface recovery vessel are provided to an off-site hydrocarbon product distribution system and a second portion of the hydrocarbon products recovered by the surface recovery vessel is used on-site to generate electricity and/or hydrocarbon products.
